(19) United States
(12) Patent Application Publication
(10) Pub. No.: US 2005/0081225 A1
(43) Pub. Date: Apr. 14, 2005

(54) Pick-up holder and drive unit for recording medium

(75) Inventors: Katsuhiko Tanimoto, Tokorozawa-shi (JP); Takeshi Hamada, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/952,433

(22) Filed: Sep. 29, 2004

(30) Foreign Application Priority Data
Sep. 30, 2003 (JP) 2003-340045

(51) Int. Cl. G11B 7/08; G11B 7/085; G11B 7/09

(52) U.S. Cl. 720/676

(57) ABSTRACT

A pick-up holder includes a holder component (72) for holding a pick-up (71) for recording and/or reproducing data on or from a recording medium, a shaft (74) for guiding slidably the holder component (72), a skew screw (80) and a guide wall (27) for engaging with the end of the shaft (74), and a torsion bar (82) for biasing the shaft (74) to the side of the skew screw (80) and the guide wall (27), in which the torsion bar (82) biases the shaft (74) in the direction intersecting with the direction that the shaft abuts against respectively the skew screw (80) and the guide wall (27). This arrangement allows the shaft (74) to be biased both in the vertical and lateral directions and to prevent backlashes in the vertical and lateral directions. Accordingly, it is possible to securely fix the shaft (74) and to improve ease of assembly with a simple construction.

### BACKGROUND OF THE INVENTION

1. Field of the Invention

The present invention relates to a pick-up holder and a drive unit for recording medium having the pick-up holder.

2. Description of Related Art

The driving unit for recording medium includes a pickup for recording and/or reproducing a discoidal recording medium and a moving mechanism for moving this pickup in the radial direction of the recording medium. This moving mechanism includes a holder for holding the pickup, which generally has a holder component for holding the pickup and fixed on a base section, a shaft for guiding the holder component slidably, an engaging component for engaging the terminal part of this shaft, and a biasing component for biasing the shaft to the engaging component side.

Traditionally, the engaging mechanism of a shaft includes a base section where the shaft is attached, a screw for engaging the shaft, and a compression coil spring. In such an engaging mechanism of the shaft, a screw is inserted into the base section, and the top of this screw head is abutted on the upper surface of the chassis, and then the same is fit into the a internal thread formed at the top of a shaft under the base section (see, for example, reference: Japanese Patent Laid Open Publication 2000-195062, page 5 line 37 and FIG. 15). And the shaft is biased to below the base section as the compression coil spring is put between the base section and the shaft. In this way, the screw head remains always immobile in contact with the top of the chassis.

According to the above literature, as the compression coil spring merely biases the shaft downward, it is possible to prevent any vertical backlash by biasing vertically. On the other hand, however, it is impossible to cope with horizontal backlash in the right and left direction. Therefore, it is necessary to add a separate leaf spring for biasing horizontally in the right and left direction. The adoption of such a structure complicates the entire apparatus and makes the assembly work cumbersome constituting a disadvantage.

### SUMMARY OF THE INVENTION

An object of the present invention is to provide a pick-up holder and a drive unit for recording medium having a simple assembly structure and capable of ensuring that the shaft is immobilized.

A pick-up holder according to an aspect of the present invention includes: a holder component for holding a pick-up for recording and/or reproducing on or from a recording medium; a shaft for guiding slidably the holder component; an engaging component for engaging with the end of the shaft; a biasing component for biasing the shaft to the side of the engaging component, in which the engaging component includes a first engaging component and a second engaging component against which the shaft can abut from the radial directions of the shaft which are mutually intersecting, and in which the biasing component includes biasing pieces that bias the shaft towards both the first engaging component and the second engaging component.

A drive unit for recording medium according to another aspect of the present invention includes the above-described pick-up holder.

### BRIEF DESCRIPTION OF THE DRAWINGS

FIG. 1 is a perspective view entirely showing a drive unit for recording medium according to an embodiment of the present invention;

FIG. 2 is an exploded perspective view of the drive unit for recording medium of the embodiment;

FIG. 3 is a plan view of the inside of the embodiment of the present invention as seen from the upper side;

FIG. 4 is a view of a part of a base section of the embodiment as seen from the upper side;

FIG. 5 is a lateral sectional view of the base section of the embodiment as seen from the lateral side;

FIG. 6 is a view corresponding to FIG. 5 showing a case that a tilt adjuster is in operation;

FIG. 7 is a front elevational view showing the pick-up holder at the tip of the shaft of the embodiment;

FIG. 8 is a front elevational view showing a torsion bar of the embodiment;

FIG. 9 a cross-sectional view showing the pick-up holder of the embodiment as viewed in the lateral direction;

FIG. 10 is a cross-sectional view as seen along the X-X line of FIG. 7;

FIG. 11 is a cross-sectional view as seen along the XI-XI line of FIG. 7;

FIGS. 12A and 12B are views respectively showing the biasing directions of the shaft at the abutting positions of an engaging piece of the torsion bar with the shaft of the embodiment;

FIGS. 13A and 13B are views respectively showing different examples of the bias directions of the shaft at the abutting positions of the engaging piece of the torsion bar with the shaft of the embodiment; and

FIG. 14 is a sectional view showing another example of pick-up holders of the embodiment.

### DETAILED DESCRIPTION OF PREFERRED EMBODIMENT(S)

An embodiment of a drive unit for recording medium of the present invention will be described below with reference to drawings.

[Construction of Drive Unit for Recording Medium]

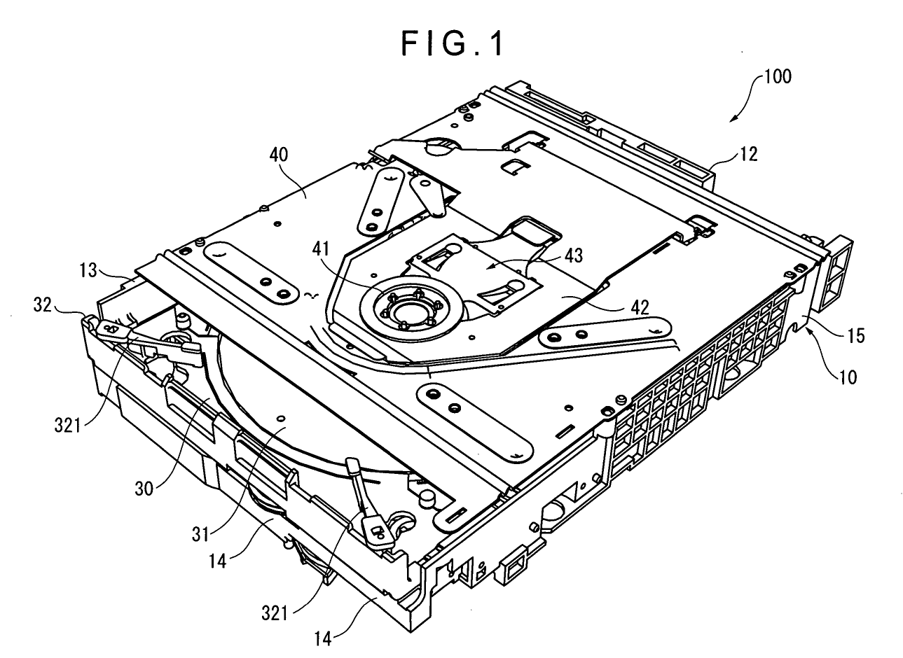

FIGS. 1 through 9 show an embodiment of the drive unit for recording medium.

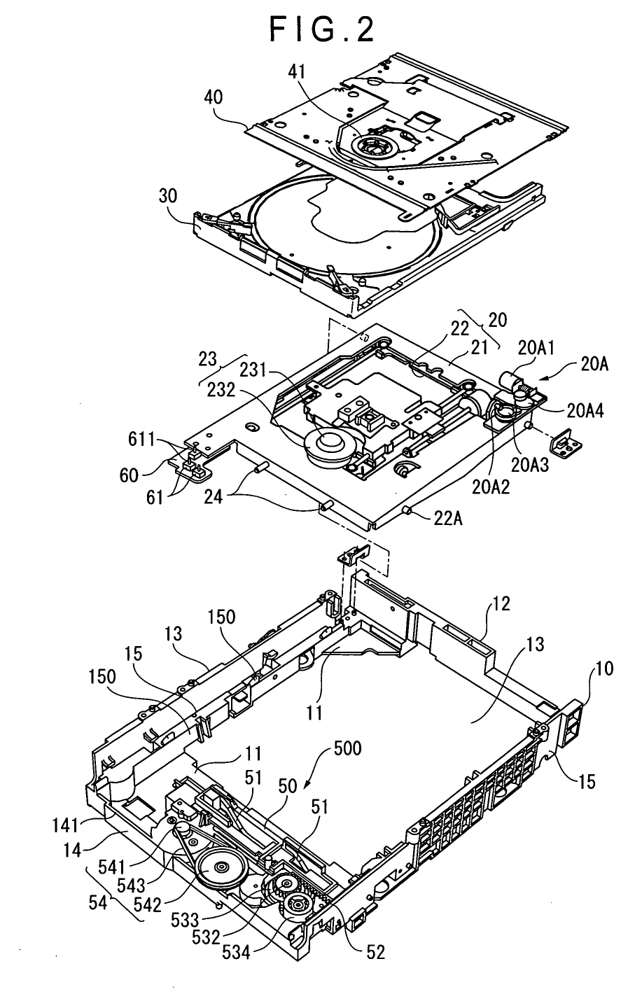

FIG. 1 is a perspective view entirely showing the drive unit for recording medium. FIG. 2 is an exploded perspective view of this drive unit for recording medium of the present invention.

In FIGS. 1 and 2, reference numeral 100 represents a drive unit for recording medium. Practical applications of this drive unit for recording medium 100 includes, for example, CD drives or DVD drives housing a CD (Compact Disc), a DVD (Digital Versatile Disc) or other recording media. Such drive units for recording medium can be housed in a personal computer or an audio apparatus. In addition, the drive unit for recording medium of the present invention is not limited to those housed in such apparatuses, but include those installed outside terminal apparatuses and audio apparatuses, or those which can be used alone such as portable CD players and any apparatuses designed to reproduce and/or record data on optical recording media.

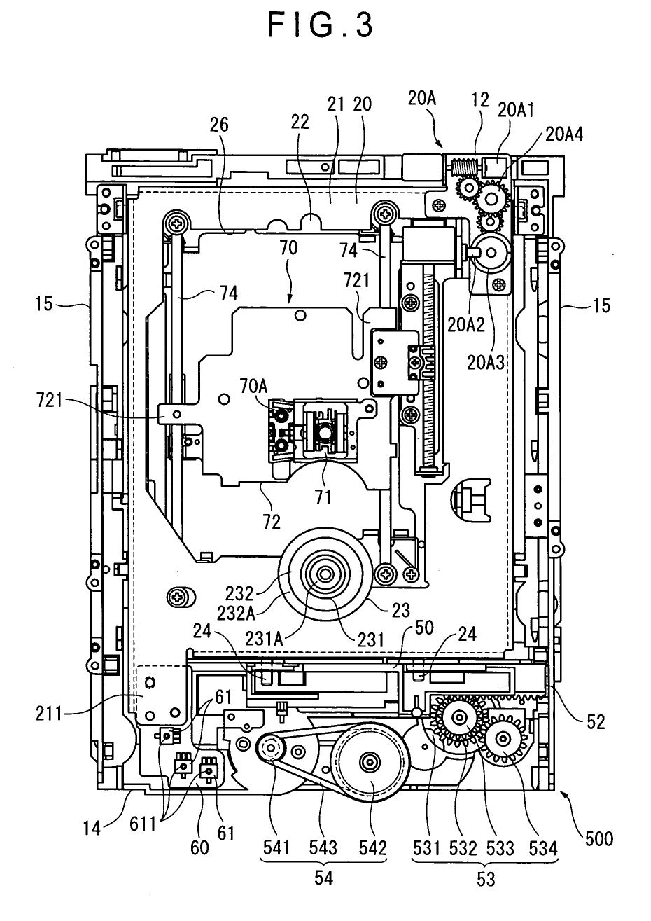

This drive unit for recording medium 100 includes a plane and almost rectangular frame 10, a base section 20 (see FIG. 3) attached within this frame 10, a tray 30 that can be introduced into and withdrawn from the frame 10, a clamping mechanism 40 covering the upper surface of the frame 10, and a metallic casing not shown covering the external peripheral surface of the frame.

{Construction of Frame}

The frame 10 is a component composed of a synthetic resin and other materials. This frame 10 is formed in approximately in a box shape with a bottom part 11 consisting of approximately plane rectangular plate component. Provided with a rear part 12 integrated with one of the shorter peripheral sides of this bottom part 11, a front part 14 rising from the bottom part 11 on the other side of the shorter peripheral sides of this bottom part 11 to be integrated therewith, and two lateral parts 15 integrated with both longer sides of the peripheral part of the bottom part 11, an upper opening 13 is formed being surrounded by these lateral parts 15 and rear part 12 and opposite to the bottom part 11.

Here in this drive unit for recording medium 100, irrespective of whether the drive unit for recording medium 100 is placed horizontally or vertically, the upper opening 13 side is defined as the upper side, the bottom part 11 side opposite thereto as the lower side, the rear part 12 side as the rear side, and the front part 14 side as the front side. And the direction along the front side to the rear side is defined as the sliding direction, the direction from the upper to the lower surface as the vertical direction and the direction to the lateral surface perpendicular to the sliding direction and the vertical direction is defined as the lateral direction.

The peripheral part of the bottom part 11 consists of lateral parts 15, a front part 14 and a rear part 12, and a hollow part is created inside thereof. The hollow part of the bottom part 11 is a space for housing electric circuits not shown, which control the operation of the drive unit for recording medium 100.

The rear part 12 includes an external terminal part not shown in the lower side, and this external terminal part is electrically connected with an electric circuit laid out in the bottom part 11 within the frame. This external terminal part includes, for example, a part for connecting power cable to supply electric power to the drive unit for recording medium and a connecting part for external terminals enabling to connect with PCs and other external apparatuses. Information reproduced and/or recorded in the drive unit for recording medium 100 is mainly input or output through this external terminal.

On the inner wall of the lateral part 15, a sliding piece 150 slidably holding the tray 30 is held in the sliding direction. And on the rear side of the lateral part 15, the base section 20 is attached oscillatably.

The front part 14 is formed smaller in dimension in the vertical direction in the figure than the rear part 12 and the lateral part 15, and on the upper side of this front part 14 an opening 141 is provided for introducing and withdrawing the tray 30. And the front part 14 includes an operating part not shown, which is connected with an electric circuit laid out in the bottom part 11. This operating part includes, for example, an ejecting button for introducing and withdrawing the tray 30, a volume control knob for controlling sound volume, and an inlet for ear-phone, and the like.

{Construction of Base Section}

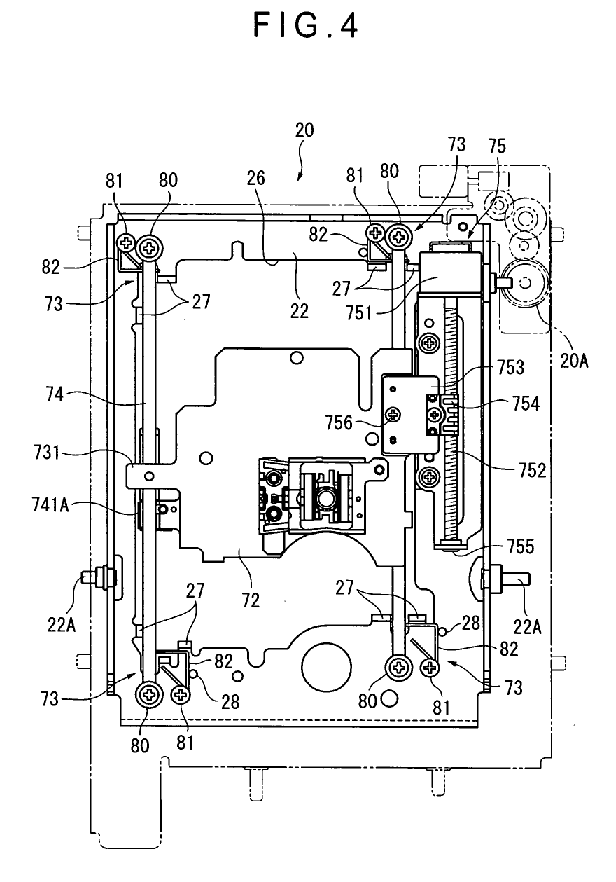

FIG. 3 is a plan view of the drive unit for recording medium 100 from which the clamping mechanism 40 and the tray 30 are removed, and FIG. 4 is a plan view of a part of the base section as seen from the upper side.

In FIGS. 2 through 4, the base section 20 includes a mechanical base 21 having a disk table 23, and a tiltable base 22 attached tiltably to this mechanical base 21 centered around a pin 22A, and the mechanical base 21 is provided with a tilt adjuster 20A for adjusting the tilt of the tiltable base 22.

The mechanical base 21 and the tiltable base 22 are respectively formed by, for example, pressing sheet metal. On the rear side of the disk table 23 of the tiltable base 22, a placement hole for reproducing/recording mechanism 26 is provided, and a reproducing/recording mechanism 70 is inserted into this placement hole for reproducing/recording mechanism 26.

The disk table 23 is attached rotatably with the vertical direction as the axis of rotation at a position separated by a predetermined distance from the front side of the mechanical base 21 and approximately at the center in the lateral direction. The disk table 23 is provided to protrude the upper side of the mechanical base 21. The adoption of this arrangement prevents any optical disc and other discoidal recording media from getting into contact with the base section 20 when they are placed on a disk table 23. This disk table 23 is provided with a rotary driving mechanism such as a motor not shown on its lower side, which is electrically connected by a flexible substrate made of synthetic resin containing the electric circuit and a current-carrying part. When an electric signal containing a drive command is transmitted from the electric circuit, this rotary driving mechanism rotates the disk table 23 at a high speed.

The disk table 23 includes a mounting part 232 for mounting a recording medium, and a taper part 231 located at the center of the mounting part 232 and the upper side of which tapers. Optical discs and other recording media have a circular hole approximately at their center, and the taper part 231 engages with this circular hole. In addition, as shown in FIG. 3, a sheet component 232A made of a synthetic resin is on the upper side of the mounting part 232 applied to protect the surface of the recording medium and to serve as an antiskid and a magnet 231A is attached on the upper side of the taper part 231. Even when the disk table 23 rotates at a high speed, due to the presence of the sheet component 232A, the recording medium does not slip and therefore the recording surface of the recording medium is not damaged.

And a detecting board attachment 211 protruding on the front side is formed on one of the corner of the front side of the mechanical base 21. On the lower side of this detecting board attachment 211, a flat detecting board 60 is fixed. For this attachment, screw attachment can be applied. On the detecting board 60, a detecting switch 61 is attached standing toward the upper side, and this detecting switch 61 is connected with the electric circuit through a wiring not shown extending to the lower side of the base section 20. At the top of each detecting switch 61, a detecting pin 611 keeps standing toward the upper side. This detecting pin is used, for example, for reading write enable and write protect or other similar information from any cartridge-type disk that may be mounted on the tray 30.

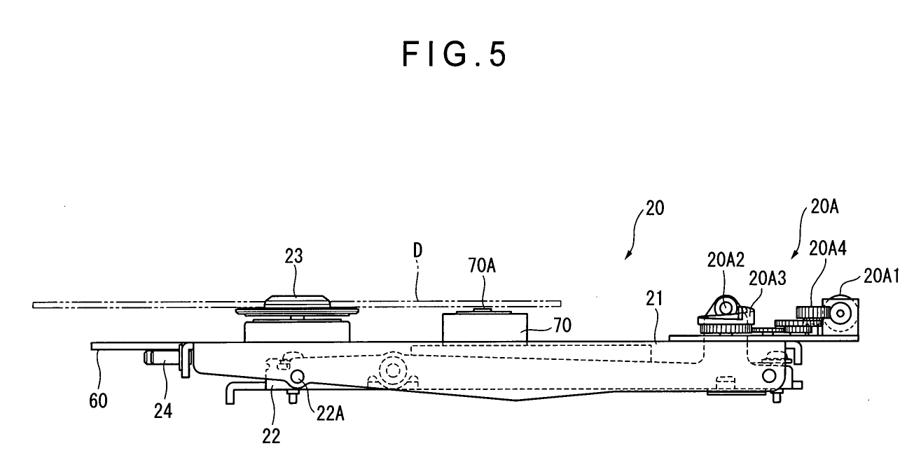

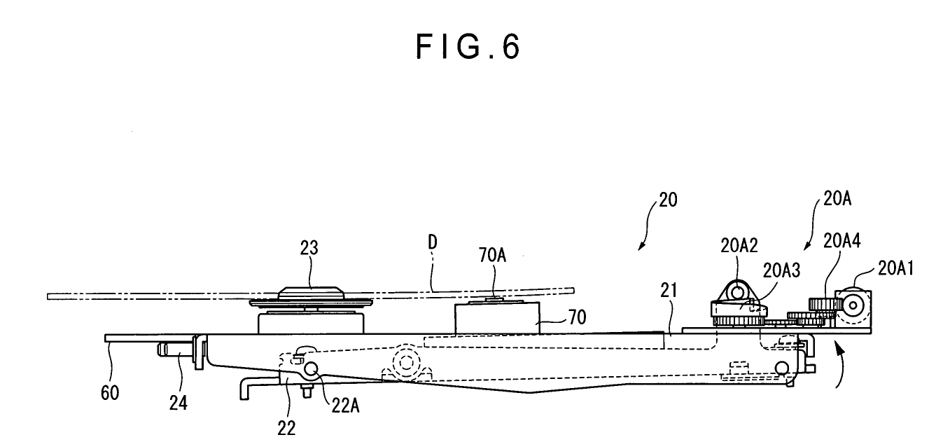

The tilt adjuster 20A is designed to tilt the recording/reproducing mechanism 70 to make sure that, when a recording medium D mounted on the disk table 23 deflects along the radial direction, a predetermined distance would be maintained with this curved surface. And the specific configuration of devices is shown in FIGS. 5 and 6.

In FIGS. 3 and 5, the tilt adjuster 20A includes a sensor 70A mounted on the recording/reproducing mechanism 70 for detecting the distance with the recording medium D, a guide pin 20A2 mounted on the edge side of the tiltable base 22, a cam 20A3 abutted on the periphery of this guide pin 20A2 and attached rotatably on the mechanical base 21, a gear mechanism 20A4 engaged with this cam 20A3, and a motor 20A1 for rotating this gear mechanism 20A4 in the normal and reverse direction in response to signals received from the sensor 70A. For example, as shown in FIG. 6, when the recording medium D is deflected increasingly upward on approaching the periphery, the tilt adjuster 20A is put into operation to lift upward the recording/reproducing mechanism 70 together with the tiltable base 22. When the recording medium D is deflected increasingly downward on approaching the periphery, on the contrary, the tilt adjuster 20A is set into operation and to shift downward the recording/reproducing mechanism 70 together with the tiltable base 22.

{Construction of Recording/Reproducing Mechanism}

This recording/reproducing mechanism 70 includes a pick-up 71 for reading and writing information on a recording medium, a holder component 72 for holding this pick-up 71, and a shaft 74 for supporting slidably this holder component 72 in the sliding direction.

The pick-up 71 enables recording and/or reproducing information by, for example, irradiating a laser beam on the recording surface of a recording medium. For the reproduction of information, a laser beam is irradiated on the recording surface and the reflection is collected through a lens. The amount of the reflected beam represents the information contained in the recording surface and enables to reproduce information. As for the recording of information, for example a laser beam or other strong beam is directly irradiated on the recording surface to record information on the recording surface corresponding to the signals of the information.

On the holder component 72, the pick-up 71 is mounted on the upper side and a pick-up sliding mechanism 75 is mounted on the lower side as shown in FIG. 4. And the holder component 72 is electrically connected with the pick-up 71 via a circuit not shown, and this circuit is electrically connected with an electric circuit not shown laid out on the bottom part 11 of the frame 10 through a flexible substrate containing a wiring circuit. When a command for reproduction and/or recording on the recording medium is transmitted from this electric circuit, the pick-up 71 executes the reproduction and/or recording on the recording medium through the circuit of the holder component 72. And the information obtained by the pick-up 71 from the recording medium and the information to be recorded on the recording medium are also transmitted through this circuit to the electric circuit.

The shaft 74 is a metal columnar component attached on the tiltable base 22 stretching over the sliding direction of the placement holes for reproducing/recording mechanism 26.

On the upper side of this shaft 74, an approximately semi-cylindrical abrading component 741 formed with a material having a small skin friction resistance such as metal or synthetic resin is attached. The inner radius of the cylindrical part of this abrading component 741 is somewhat larger than the radius of the periphery of the shaft 74, and it is fitted in such a way that the cylindrical part of this abrading component 741 may envelope the shaft 74. And the lower side of the abrading component 741 is fixed on the holder component 72 at the shaft connecting part 721 provided on the lateral side of the holder component 72. At this time, the shaft 74 abuts on both the abrading component 741 and the shaft connecting part 721 of the holder component 72, and as a result the holder component 72 becomes slidable. In addition, the shape of the abrading component 741 is not limited to this, but may be, for example, an approximately cylindrical component the inner radius of which is somewhat larger than the shaft 74. In this case, the only requirement is that the shaft 74 penetrates the inner dimension side of the abrading component, and the holder component 72 is fixed on the lower side thereof. Furthermore, the holder component 72 and the abrading component 741 may be integrated.

(Pick-Up Sliding Mechanism)

The pick-up sliding mechanism 75 is a mechanism for sliding the holder component 72, and includes a screw shaft 752, a screw driver 751 mounted on an end of the screw shaft 752, and a screw bearing 755 bearing the rotation of the screw shaft 752 on the other end.

This pick-up sliding mechanism 75 is provided on one side of the holder component 72 in the present embodiment, but this may be provided on any side, right or left. In other words, the pick-up sliding mechanism 75 may be positioned according to the convenience of designer in consideration of other components of the drive unit for recording medium.

The screw shaft 752 is a metallic cylindrical bar component having a helical screw on its periphery, and is fixed in parallel with shaft 74 in the base section 20. The screw driver 751 houses inside a motor not shown, and is connected electrically with the electric circuit. When the motor starts running in response to a control signal output by the electric circuit, the screw shaft 752 begins to rotate around its axis. At this time, the screw bearing 755 bears this rotary motion and prevents the screw shaft 752 from dislocating itself due to rotation. And the screw bearing 755 prevents the screw shaft 752 from dislocating itself from its axis in order to keep the screw shaft 752 and shaft 74 in parallel.

And the screw abutting part 753 is fixed on the lower side of the holder component 72, and the abutting piece 754 of this screw abutting part 753 abuts on the screw shaft 752. The abutting piece 754 has a plurality of protrusions along the screw grooves of the screw shaft 752, and when the screw shaft 752 beings to rotate around the shaft of the screw shaft 752, the abutting piece 754 can slide in the sliding direction in response to the rotation of this screw. And as a result, the holder component 72 that fixes the screw abutting part 753 can slide in the sliding direction. In addition, when the screw shaft 752 is not running, the abutting piece 754 is restricted of its movement at a position of the screw shaft 752. In this way, any unnecessary movement of the holder component 72 can be prevented.

(Fixture of Recording/Reproducing Mechanism to Base Section)

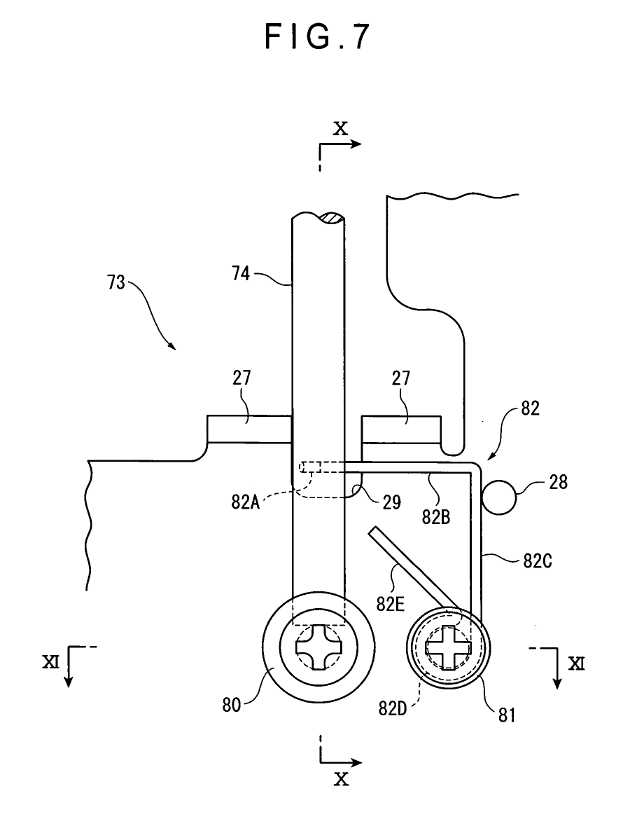

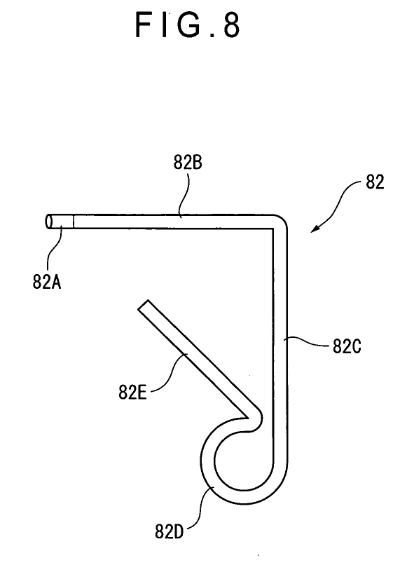

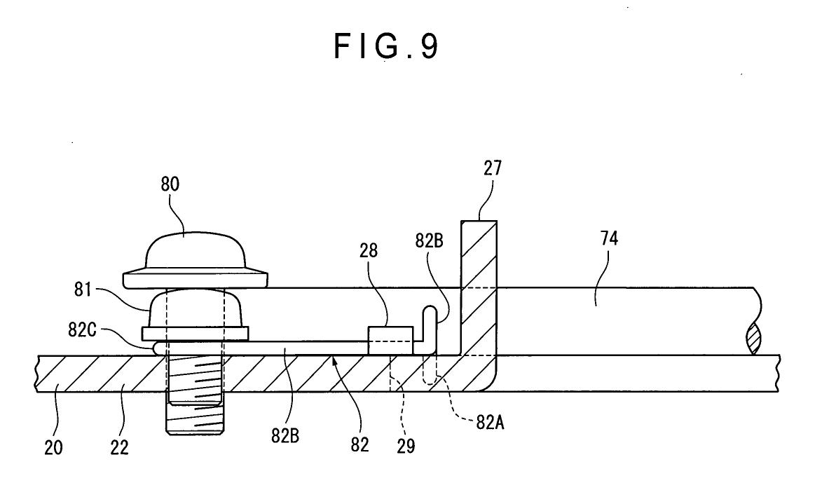

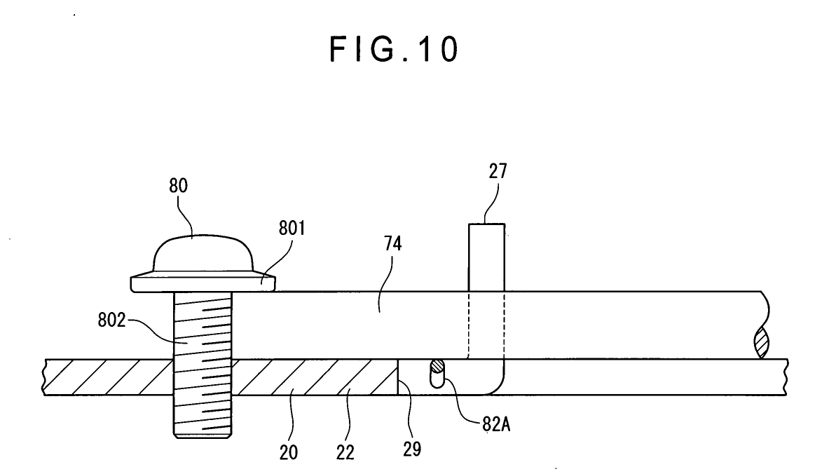

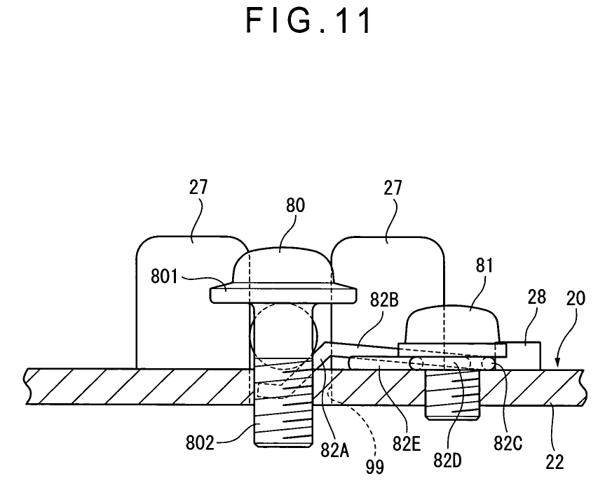

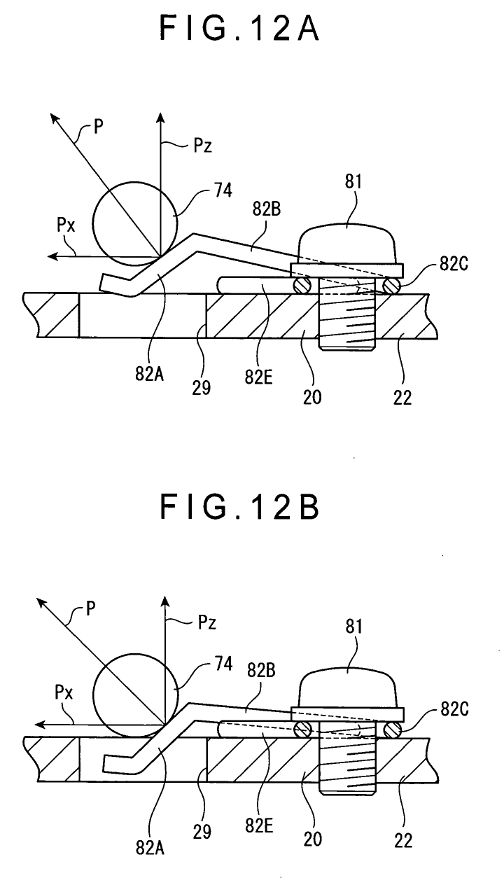

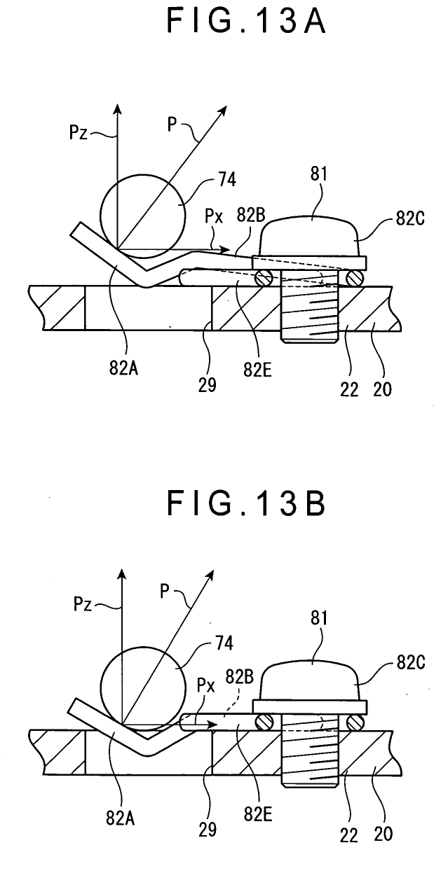

And now, the pick-up holder 73 for fixing such recording/reproducing mechanism 70 to the tiltable base 22 of the base section 20 will be described below. FIG. 7 is an enlarged detail of the fixture of the shaft 74 to the base section 20 at the edge. FIG. 8 is a front elevational view of a torsion bar for biasing the shaft 74. FIG. 9 is a cross-sectional view of the fixing mechanism of the shaft 74 shown in FIG. 7 as seen in the lateral direction. FIG. 10 is a cross-sectional view of along the chain line X-X of FIG. 7. FIG. 11 is a cross sectional view along the line XI-XI of FIG. 7. FIGS. 12A and 12B are illustrations showing respectively the biasing directions of the shaft 74 at the abutting positions between the engaging piece 82A and the shaft 74, and FIGS. 13A and 13B are illustrations showing respectively different examples of biasing directions of the shaft 74 at the abutting positions between the engaging piece 82A and the shaft 74.

In FIGS. 4, and 7 through 9, the pick-up holder 73 includes a shaft 74, a skew screw 80 which is the first engaging component for engaging this shaft 74 from movements in the vertical direction, a guide wall 27 which is the second engaging component for guiding and positioning this shaft 74 and a torsion bar 82 which is a biasing component.

The guide wall 27 is provided in pairs on both sides of the shaft 74. And this guide wall 27 is integrated with the tiltable base 22 by press working and other forms of sheet metal processing. The interval between a pair of guide walls 27 is kept at a slightly larger value than the diameter of the shaft 74. And at the base section 20 between these pairs of guide walls 27 notched holes 29 are perforated. These notched holes 29 are perforated to facilitate the work of bending the guide walls 27 integrated with the tiltable base 22 to the plane direction of the tiltable base 22 in the process of press working.

The skew screw 80 is screwed into an internal thread not shown but previously provided on a tiltable base 22 of the base section 20 for fixing. The column edge at the top of the shaft 74, abutting against the external thread 802 of this skew screw 80, determines the position of the shaft 74 in the sliding direction. And the screw head 801 of the skew screw 80, abutting against the column periphery at the top of the shaft 74, determines the position in the vertical direction of the shaft 74 (in the direction of approach to and separation from the tiltable base 22). And by means of adjustments to the extent of screwing into the tiltable base 22, this skew screw 80 can adjust the distance from the tiltable base 22 to the screw head 801 of the skew screw 80 and thus adjust the height of the shaft 74. This arrangement enables to adjust the distance between the pick-up 71 and the recording medium.

In FIGS. 7 and 8, the torsion bar 82 is a component formed by integrating an engaging piece 82A abutting against the shaft 74, a connecting part 82B extending from the engaging piece 82A at a predetermined angle, a shaft part 82C extending approximately directly to the edge of the connecting part 82B, an approximately circular fixture 82D provided at the edge of the shaft part 82C, and a position holder 82E extending in the direction separating from the edge of the fixture 82D and the shaft part 82C at the time of assembly. Such a torsion bar 82 is formed by bending a metal rod with a single elasticity.

The engaging piece 82A is formed approximately in the V shape as shown in FIG. 11, and the shaft 74 abuts against one side of this V shape in the direction of biasing to the guide wall 27 side (in the lateral direction) and in the direction of biasing to the screw head 801 of the skew screw 80 side. And the engaging piece 82A and the connecting part 82B form a prescribed angle vis-a-vis the plane direction of the tiltable base 22, formed being bent approximately in the form of the V shape. On the other hand, the shaft part 82C is disposed along the plane direction of the tiltable base 22, and the fixture 82D formed at the edge of the shaft part 82C is fixed by a screw 81 on the same plane as the plane direction of the tiltable base 22 being separated by a required distance from a skew screw 80. At this time, the fixture 82D is fixed in such a way that the shaft part 82C may abut against a positioning protrusion 28 set up in the tiltable base 22. And the means of fixing is not limited to screws but may be any other means of fixing.

Such a torsion bar 82 is set up at a position where the engaging piece 82A abuts against the upper side of the shaft 74 and the notched hole 29 of the base section 20 may be accessible to this engaging piece 82A. At this time, the torsion bar 82 is fixed in such a way that the engaging piece 82A and the connecting part 82B may be approximately perpendicular to the shaft direction of the shaft 74. When, in such a condition, the shaft 74 is pushed to the side of the base section 20 by making adjustments on the skew screw 80, the shaft part 82C is positioned by abutting against the positioning protrusion 28, and therefore the torsion bar 82 cannot escape in the direction of the flat surface of the base section 20. Accordingly, the engaging piece 82A is forced into the notched hole 29.

When the engaging piece 82A is forced into the notched hole 29, the connecting part 82B also is biased towards the base section 20, and this power twists the shaft part 82C around the shaft. And the reactive force to this twist of the shaft part 82C (twisting force) gives to the connecting part 82B an arcuate biasing force around the connecting point between the shaft part 82C and the connecting part 82B. In addition, at this time, some deflection has developed in the connecting part 82B, and the reactive force to this deflection produces biasing force. By these biasing forces, the engaging piece 82A connected with the connecting part 82B can obtain biasing forces directed in the vertical direction and lateral direction. And this biasing force biases the shaft 74 at the same time in the vertical direction and the lateral direction. Accordingly, the shaft 74 abuts against either the screw head 801 of the skew screw 80 or a pair of guide walls 27 for positioning.

In the present embodiment, the torsion bar 82 is used in a variety of ways to place the drive unit for recording medium 100 horizontally or vertically. As shown in FIGS. 12A and 12B, when a side of the engaging piece 82A in contact with the shaft 74 is on the adjacent side to the connecting part 82B, the shaft 74 is biased by the biasing power P on the side opposite to the connecting part 82B. At this time, the biasing power P is broken into the vertical direction Px and the lateral direction Pz depending on the clamping condition of the skew crew 80, the angle between the engaging piece 82A and the connecting part 82B, and the angle between the connecting part 82B and the base section 20. On the other hand, as shown in FIGS. 13A and 13B, when the shaft 74 is in contact with the side separated from the connecting part 82B of the engaging piece 82A, the shaft 74 is biased by the biasing power P in the direction of the connecting part 82B. At this time also, the biasing power P is broken into the vertical direction Pz and the lateral direction Pz depending on the clamping condition of the skew screw 80, the angle between the engaging piece 82A and the connecting part 82B, and the angle between the connecting part 82B and the base section 20. Incidentally, FIGS. 12A and 13A show the condition wherein the shaft 74 is separated from the tiltable base 22, while FIGS. 12B and 13B show the condition wherein they are close each other. By making such an arrangement, it is possible to ensure that the backlash in the lateral direction of the shaft 74 would be suppressed without application of unnatural force.

And the position holder 82E is designed to hold the position of the torsion bar 82 when the same is attached to the tiltable base 22. This is provided in view of the fact that, in the absence of the position holder 82E leaving only the fixture 82D, the torsion bar 82 remains tilted because of the gravity of the engaging piece 82A and the connecting part 82B, and its ease of assembly is affected adversely. When the position holder 82E is added to the edge of the fixture 82D, on the other hand, this position holder 82E, abutting against the tiltable base 22, bears the gravity of the engaging piece 82A and the connecting part 82B, and the torsion bar 82 does not get tilted.

{Construction of Tray}

The tray 30 is a component formed with, for example, ABS resin and other synthetic resins, and is housed, for example, within the drive unit for recording medium for mounting recording media such as CDs and DVDs. The tray 30 includes a mounting surface 31 formed in a plane rectangular shape, and a rising part 32 for rising from the front side on the periphery of the mounting surface 31. On the lateral surface of the lower side of the tray 30, a rectilinear groove part not shown is integrated along the direction in which the tray 30 slides, and the sliding piece 150 of the lateral part 15 is engaged in this groove part. The tray 30 can smoothly slide in the sliding direction due to these groove part and the sliding piece 150.

The mounting surface 31 is a surface for mounting optical recording media such as CDs and DVDs. At the approximate center of this mounting surface 31, a hole is provided. When the tray 30 is housed within the frame 10, the disk table 23 protrudes through this hole to the side of the mounting surface 31 to hold the recording medium. And through this hole the pick-up 71 accesses to the recording surface of the recording medium and enables to reproduce and/or record data from and on the recording medium.

The rising part 32 functions as a lid for covering the front side of the tray 30 and to hide the front opening 141. It also prevents the recording medium from falling out of the mounting surface 31 to the front side when the recording medium is not held in the disk table 23. This rising part 32 includes a disk holder 321, which serves to position the recording medium to be mounted on the mounting surface 31.

{Construction of Clamping Mechanism and Holding of Recording Medium}

The clamping mechanism 40 is attached on the upper opening 13 of the frame 10, and this clamping mechanism 40 is a mechanism for holding the recording medium engaged by the disk table 23 so that the recording medium may not fall out of the disk table 23. The clamping mechanism 40 is provided with a clamp 41 at a position opposite to the disk table 23. This clamp 41 is supported by the clamp holder 42. The clamp 41 is made of a synthetic resin, and a discoidal metal component not shown is inserted on the upper side of its central part. The clamp holder 42 is provided with a leaf spring 43, which serves to bias upward the clamp holder 42 when the same has fallen down to the lower side.

The case of using the drive unit for recording medium 100 having this clamping mechanism 40 wherein a discoidal optical disk as a recording medium is mounted on the mounting surface 31 of the tray 30 and the tray 30 is housed within a frame 10 will be described as an example. In this case, the circular hole of the optical disk is engaged with the taper part 231 of the disk table 23, and an optical disk is mounted on the sheet component 232A of the mounting part 232. And since a magnet is inserted in the taper part 231 of the disk table 23, this optical disk can be pinched with the clamp 41, and thus the optical disk is fixed in such a way that it may not fall out from the disk table 23. At this time, the clamp 41 abuts against the disk table 23 by the magnet 231A of the disk table 23, and at the same time the clamp holder 42 is deflected downward. As a result, even if the disk table 23 rotates at a high speed during the reproduction and/or recording of the optical disk, the optical disk does not fall off the disk table.

For removing the optical disk, the disk table 23 descends to the lower side, the magnet 231A and the clamp 41 are separated, and the clamp 41 is lifted by the leaf spring 43 to the upper side together with the clamp holder 42. And when the disk table 23 descends to the side lower than the mounting surface 31, the disk is mounted on the upper side of the mounting surface 31, and the recording medium can be taken out by discharging the tray 30 from the frame 10.

{Connection between Base Section 20 and Tray}

In FIGS. 2 and 3, an interlocking mechanism 500 is provided on the front side of the base section 20. This interlocking mechanism 500 includes a drive cam 50 engaged with the base section 20, a first rack 52 integrated with the drive cam 50, a gear mechanism 53 engaged with this first rack 52 and having a first gear 531 through a fourth gear 534, a motor section 54 engaged with this gear mechanism 53 and driven by the control of the electric circuit, and a second rack not shown provided at the lower side of the tray 30 and engaged with the gear mechanism 53.

The drive cam 50 is formed by a synthetic resin or the like and is disposed slidably in both directions in the sliding direction of the tray 30 and in the lateral direction perpendicular to the same. On the rear side of the drive cam 50, a cam groove 51 extending in the lateral direction is formed, and the cam engaging pin 24 of the base section 20 is engaged with this cam groove 51. The cam groove 51 is formed with the midway of the lateral direction being slanted so that one end may be disposed on the upper side and the other end may be disposed on the lower side. As this drive cam 50 travels in both directions on the lateral direction, the cam engaging pin 24 takes this slanting part and travels between the both ends of the cam groove 51. And this enables the base section 20 to travel in both ways.

The first rack 52 formed on one side of this drive cam 50 is engaged with the third gear 533 of the gear mechanism 53. On the lower side of this third gear 533, the second gear 532 having a greater diameter than the third gear 533 is integrated, and this second gear 532 is engaged with the first gear 531 and the fourth gear 534.

The first gear 531 is engaged with the motor gear 542 of the motor section 54. The motor gear 542 is linked with a wheel 541 and an annular belt 543 made of a synthetic resin. On the lower side of the wheel 541, a motor body not shown is provided through the frame 10, and this motor body directly supplies driving power. The motor body is electrically connected with the electric circuit, and the electric circuit controls the rotation of the motor body.

The fourth gear 534 is engaged with the second rack not shown and provided on the lower side of the tray 30.

When a tray sliding command is transmitted to the electronic circuit by applying pressure on the ejecting button not shown and provided on the front part 14 of the frame 10 or by an input from outside, the electronic circuit drives the motor body. When the motor body begins to run, its rotation is transmitted through the wheel 541 and the motor gear 542 to the first gear 531 of the gear mechanism 53. And the rotary motive force is transferred from the first gear 531 to the second gear 532, and the third gear 533 integrated with this second gear 532 and the fourth gear 534 engaged with the second gear 532 rotate. By the rotation of the third gear 533, the drive cam 50 engaged with this third gear 533 at the first rack 52 moves in the lateral direction, and the base section 20 engaged with the drive cam 50 moves to the upper side or the lower side. And as the fourth gear 534 rotates, the tray 30 engaged with the fourth gear 534 at the second rack moves to the rear side or the front side.

In this way, the base section 20 and the tray 30 are linked by the drive cam 50 and the gear mechanism 53. And for discharging the tray 30, the disk table 23 must descend to the lower side before the tray 30 is to be ejected. This operation is performed by the control of sliding of the tray 30 and the second rack. For this control, for example, the tray 30 is set to be slidable over a predetermined distance in relation to the second rack. In this case, when an ejection command of the tray 30 is given by the ejecting button and the like, the motor section 54 starts running, and through the interlocking mechanism 500, the base section descends to the lower side. At this time, the fourth gear 534 rotates at the same time and the second rack is interlocked. However, this second rack is set to be slidable only over a predetermined distance in relation to the tray 30, and for this predetermined distance the second rack only moves to the front side. And when the base section 20 descends to the lower side to find an enough distance for not interfering with the tray 30, the second rack engages with the tray 30 and moves the tray 30 to the front side. And an idler adjusting mechanism not shown is provided for controlling the sliding of this tray 30 and the second rack when the tray 30 has traveled to the rear side to be housed within the frame.

Furthermore, when the tray 30 is to be introduced, in order to avoid any interference between the tray 30 and the disk table 23, the tray 30 must be introduced first and then this disk table 23 must be lifted up to the upper side. For this purpose, a timing adjustment mechanism not shown is provided between the tray 30 and the drive cam 50.

[Effects of Drive Unit for Recording Medium of Present Embodiment]

By adopting such drive unit for recording medium 100, it is possible to obtain the following effects:

(1) The drive unit for recording medium 100 of the present embodiment includes the holder component 72 for holding the pick-up 71 for recording and/or reproducing data in relation to the recording medium, the shaft 74 for guiding slidably this holder component 72, the skew screw 80 and guide walls 27 for engaging the edge of this shaft 74, and the torsion bar 82 for biasing the shaft 74 to the side of the skew screw 80 and the guide walls 27. And the skew screw 80 abuts against the shaft 74 in the vertical direction, the guide walls 27 abut against the shaft 74 in the lateral direction, and the torsion bar 82 biases this shaft 74 in the intersecting directions respectively against the skew screw 80 and the guide walls 27. In this way, by simply attaching a torsion bar 82, the shaft 74 is biased in both the vertical and lateral directions and can prevent vertical and lateral backlash. Thus, it is possible to ensure that the shaft 74 is fixed securely with a simple construction.

(2) The torsion bar 82 includes the engaging piece 82A abutting against the shaft 74 and the shaft part 82C that gives a biasing force by twisting against this engaging piece 82A, and the shaft part 82C is fixed in the base section 20 to which the shaft 74, the guide walls 27 and the skew screw 80 are attached. This arrangement enables the engaging piece 82A to take advantage of the twisting force of the shaft part 82C of the torsion bar 82 and to easily bias the shaft 74 towards the skew screw 80 and the guide walls 27. In addition, the use of the torsion bar 82 can restrict the thickness dimension of the engaging piece 82A to less than the diameter of the wire rod of the torsion bar 82. Accordingly, it is possible to obtain a biasing force sufficient to fix securely the shaft 74 and to contribute to making the entire product thinner.

(3) The base section 20 includes the notched hole 29 designed to prevent the engaging piece 82A from interfering, and this notched hole 29 is integrated into the base section 20. This arrangement enables the engaging piece 82A of the torsion bar 82 to escape to the notched hole 29 when the shaft 74 is pushed to the side of the base section 20 by adjusting the skew screw 80 so that the engaging piece 82A may not interfere with the base section 20. For this reason, even when the shaft 74 is pushed to the side of the base section 20, the engaging piece 82A of the torsion bar 82 does not interfere with the base section 20 and eliminates the necessity of additional dimensions. Thus, it is possible to limit the dimensions of the base section 20 to less than the thickness dimensions of the diameter of the torsion bar 82 and to contribute to the effort of making the whole product thinner.

(4) The torsion bar 82 includes the position holder 82E for holding the engaging piece 82A in a prescribed position in its shaft part 82C through a fixture 82D. This arrangement enables this position holder 82E to bear the gravity of the engaging piece 82A and the connecting part 82B, when this torsion bar 82 is attached to the base section 20. Therefore, the torsion bar 82 can maintain its position without tilting when it is attached, and the torsion bar 82 can be easily attached and its ease of assembly improves.

(5) The engaging piece 82A, the connecting part 82B, the shaft part 82C, the fixture 82D and the position holder 82E are integrated by a wire rod. This arrangement enables to form a torsion bar 82 by bending a single wire rod. Therefore, it is possible to form easily a torsion bar 82 without increasing the number of component parts.

(6) The position for attaching a torsion bar 82 in the base section 20 and the position for attaching the skew screw 80 in the tiltable base 22 are separated by a prescribed distance in the plane level direction. This arrangement eliminates the alignment of the shaft 74, the skew screw 80 and the fixture 82D of the torsion bar 82 on the same level and contributes to the effort of making the whole product thinner.

(7) The positioning protrusion 28 is formed on the tiltable base 22, and the fixture 82D is fixed in such a way that the shaft part 82C may abut against this positioning protrusion 28. This arrangement allows the positioning protrusion 28 to serve as a positioning marker for the shaft part 82C when the fixture 82D is fixed and at the same time prevents the displacement of the shaft part 82C and causes the shaft part 82C to generate a twisting force when the engaging piece 82A is pressed and a force is applied in the lateral direction. Therefore, the positioning protrusion 28 facilitates the work of attaching the torsion bar 82 and in addition ensures that the shaft 74 is biased correctly when it is fixed.

(8) The direction of biasing the shaft 74 and its biasing force in various directions can be adjusted depending on the shape of the torsion bar 82 used or the position where the shaft 74 is kept abutted thereto. This arrangement enables to choose the torsion bar 82 adapted to the position of the guide walls 27 and the screwing condition of the skew screw 80. Thus, it is possible to fine-tune the biasing direction of the shaft 74 with a simple construction.

(9) As the drive unit for recording medium 100 is equipped with a pick-up holder 73, it is possible to provide the drive unit for recording medium 100 having the above-mentioned actions and effects.

(10) The present embodiment incorporates the tilt adjuster 20A for tilting the recording/reproducing mechanism 70 designed to ensure that the distance with any deflected surface remains constant when the recording medium D mounted on the disk table 23 has deflected along the radial direction. Therefore, in conjunction with the action of the torsion bar 82, it is possible to operate with a good precision the recording/reproducing mechanism 70.

[Modifications of Embodiment]

The present invention is not limited to the embodiment described above, and includes any modifications or improvements that may be made to the extent to which the object of the present invention may be achieved.

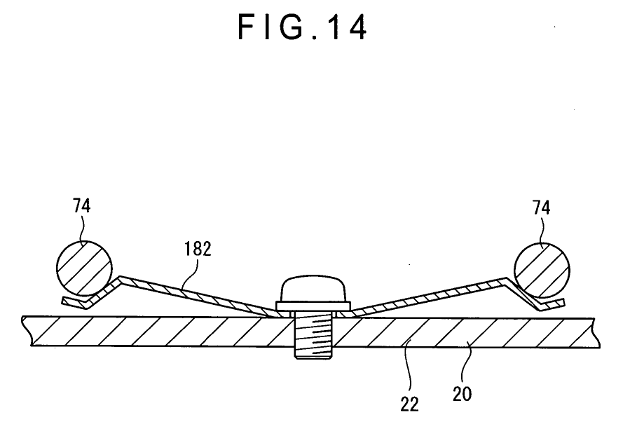

For example, the embodiment described above adopted the torsion bar 82 as a means of biasing. But this is not exclusive. For example, a leaf spring may be used as a means of biasing. In this case, for example, as shown in FIG. 14, both edges of the leaf spring 182 may be kept abutted against the shaft 74 and the approximate center thereof may be fixed to the base section 20 by a fixing screw. In this construction, it will be possible to use a leaf spring 182 to bias the shaft 74 in the direction of the skew screw 80 and the guide walls 27. Such a leaf spring 182 may be designed to form engaging pieces at its both ends and its center may be chosen as the point of fixation. It can be easily fitted and a single leaf spring can be used to bias two shafts 74. Moreover, it can be formed simply at a low cost. And in a construction shown in FIG. 14, the torsion bar used in the embodiment described above can be used.

In addition, in the present embodiment, the pair of guide walls 27 are integrated with the base section 20 at the top of the shaft 74, and the notched hole 29 is also made in the base section 20, but these examples are not exhaustive. For example, the shaft 74 may be guided to the top of the shaft 74, and in addition guide walls for positioning may be separately fixed at the base section. And in a type wherein the guide walls are separately attached, a guide abutted against the edge of the top of the shaft 74 part for positioning in the longitudinal direction may be provided in place of the skew screw 80, and a skew screw may be provided between the placement hole for recording/reproducing mechanism 26 and this guide part for vertical positioning.

Furthermore, in the present embodiment, at the edges of the shaft 74 the pair of guide walls are respectively disposed facing each other across the shaft 74. But the present invention is not limited to such an arrangement. For example, the guide walls may be provided only on the side where the shaft 74 is biased by the torsion bar 82.

And in the present embodiment, a pick-up holder 73 is provided respectively at the ends of the shaft 74. But the present invention is not limited to such an arrangement. Specifically speaking, the pick-up holder 73 may be provided at least on an end of the shaft 74. For example, a pick-up holder 73 may be provided at an end of the shaft 74 and a shaft guide component may be provided at another end of the shaft 74 for positioning the shaft direction of the shaft 74 and for guiding in the lateral direction. Even in such a case, due to the biasing of the shaft 74 in the lateral and vertical directions by the torsion bar 82 of the pick-up holder 73 provided at an end, the shaft 74 can be fixed, and in addition as only the shaft guide component is required to be provided at another end of this shaft 74, the construction can be simplified and the number of component parts can be reduced.

In the present embodiment, the holder component 72 shown in FIGS. 3 and 4 is one that occupies a relatively large space, but the present invention is not specifically limited to such space. For example, anything that has a space sufficient to hold the pick-up can do, and any product further miniaturized is acceptable. In this case, the interval between the shafts 74 can be further reduced for their disposition. The adoption of such an arrangement will reduce the space occupied by the recording/reproducing mechanism, and space can be utilized effectively.

And in the present embodiment, the pick-up sliding mechanism 75 is provided on either one of the two shafts 74. This can be provided, as described above, on either side of the holder component 72.

And in the present embodiment, the drive unit for recording medium contained in a terminal or audio equipment or housing inside a tray on which optical disks or other recording media are mounted is shown as an example. The present invention is not, however, limited to this case. Specifically speaking, as described above, the pick-up holder of the present invention may be, for example, an external type installed separately from any terminal or audio equipment, or an independently operating product such as portable CD players. In other words, the present invention can be applied to any apparatus housing CD, DVD or any other recording media inside and reproducing and/or recording data from and/or on such recording media.

In addition, the present invention does not necessarily require any tilt adjuster 20A for tilting the recording/reproducing mechanism 70, and the mechanical base 21 and the tiltable base 22 may be integrated to form the base section 20.

1. A pick-up holder comprising:
a holder component for holding a pick-up for recording and/or reproducing on or from a recording medium;
a shaft for guiding slidably the holder component;
an engaging component for engaging with the end of the shaft;
a biasing component for biasing the shaft to the side of the engaging component,
wherein the engaging component includes a first engaging component and a second engaging component against which the shaft can abut from the radial directions of the shaft which are mutually intersecting, and
wherein the biasing component includes biasing pieces that bias the shaft towards both the first engaging component and the second engaging component.

2. The pick-up holder according to claim 1,
wherein the biasing component is a torsion bar having an engaging piece for abutting against the shaft, and a shaft part for giving a biasing force in a twisted direction to the engaging piece, and
wherein the shaft part is fixed on the shaft and on a base section on which the engaging component is attached.

3. The pick-up holder according to claim 2,
wherein the base section has a hole for preventing the engaging piece for interfering, and
wherein the hole is integrated with the base section.

4. The pick-up holder according to claim 2, wherein the torsion bar has a position holder for holding the engaging piece at a predetermined position fixed on the shaft part.

5. The pick-up holder according to claim 4, wherein the engaging piece, the shaft part and the position holder are integrated by a wire rod.

6. The pick-up holder according to claim 5, wherein the position of attaching the torsion bar in the base section and the position of attaching the engaging component in the base section are separated by a predetermined distance on the plane level of the base section.

7. A drive unit for recording medium comprising a pick-up holder,
the pick-up holder including:
a holder component for holding a pick-up for recording and/or reproducing on or from a recording medium;
a shaft for guiding slidably the holder component;
an engaging component for engaging with the end of the shaft;
a biasing component for biasing the shaft to the side of the engaging component,
wherein the engaging component includes a first engaging component and a second engaging component against which the shaft can abut from the radial directions of the shaft which are mutually intersecting, and
wherein the biasing component includes biasing pieces that bias the shaft towards both the first engaging component and the second engaging component.
